(19) United States
(12) Patent Application Publication
(10) Pub. No.: US 2009/0327906 A1
(43) Pub. Date: Dec. 31, 2009

(54) SUPPORTING BRAND ASSETS IN A SOCIAL NETWORKING SERVICE

(75) Inventor: Charles O. Heinemann, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/164,604

(22) Filed: Jun. 30, 2008

(51) Int. Cl. G06F 3/048

(52) U.S. Cl. 715/739

(57) ABSTRACT

Brand assets including iconography, background images, slogans, and the like are supported in a social networking service by an arrangement that enables service members to visit a brand site to select and then embed the brand assets into their personal profile on the service. Brand assets can then be treated as any other asset used by the member and may thus be shared with other users, rated, and discussed. Brands can be associated with a variety of different brand sources including, for example, personalities, artists, celebrities, products, services, and institutions, in both commercial and non-commercial contexts.

### BACKGROUND

Web-based social networking has become a popular way for people to meet and interact with people over public networks like the Internet. Typically, social networking is implemented by websites that provide a social networking service. Social networking services are often stand alone or dedicated web-based services although some services are integrated as part of other service offerings. For example, Microsoft Corporation provides the “Zune Social” brand of social networking service in combination with a media content delivery service for its popular Zune® brand of personal media player.

To use a web-based social networking service, a member may provide information to set up an account with a social networking service. Once members' account are configured, they can generate “profiles” of themselves. The profiles typically contain a variety of information about a user (such as location, occupation, hobbies, likes/dislikes, friends/social graph, etc.).

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Brand assets including iconography, background images, slogans, and the like are supported in a social networking service by an arrangement that enables service members to visit a brand site to select and then embed the brand assets into their personal profile on the service. Brand assets can then be treated as any other asset used by the member and may thus be shared with other users, rated, and discussed. Brands can be associated with a variety of different brand sources including, for example, personalities, artists, celebrities, products, services, and institutions, in both commercial and non-commercial contexts.

In various illustrative examples, the social networking service is supplemented by an on-line media content delivery service. The media content delivery service is adapted to enable media content to be selected, delivered, and rendered on the personal media player as well as a client PC that is connected to the service over the Internet. The member's profile page in the social networking service uses a construct of a “member card” which is automatically kept up to date to reflect the music the member plays on his player or on the client PC. The member card can be customized with the member's own pictures, background, and status updates, for example, as well as brand assets that the member may select and embed in the member card. The member card assets, including brand assets (or a subset of the brand assets), may also reside on the PC player application and the personal media player, and can be transferred to other players using a wireless peer-to-peer communications protocol.

Advantageously, the present support of brand assets in a social networking service environment gives members even more ways to customize and personalize their on-line identities. Many people strongly associate with brands particularly as there is often a significant cultural connection between consumption habits and lifestyle in many parts of the world. For these people, brands can be important parts of both their real and on-line personas and being able to embed and share brand assets will help to enhance their social networking experiences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative usage environment in which a user may listen to audio content and watch video content rendered by an illustrative personal media player;

FIG. 2 shows a front view of an illustrative personal media player that supports a graphical user interface (“GUI”) on a display screen, as well as user controls;

FIG. 3 shows the portable media player when docked in a docking station that is operatively coupled to a PC and where the PC is connected to a media content delivery and a social networking service over a network such as the Internet;

FIG. 4 shows an illustrative member card which is utilized as part of any member's profile page that is supported by a social networking service;

FIG. 5 shows an illustrative GUI that enables a social networking service member to select and acquire brand assets for use in his member card;

FIG. 6 shows an illustrative member card with embedded brand assets;

FIG. 7 shows an illustrative personal media player on which a subset of brand assets from a member card are installed, and which may be wirelessly transferred to another player using a wireless communications protocol in support of peer-to-peer networking;

FIG. 8 is a simplified block diagram that shows various functional components of an illustrative example of a personal media player; and

FIG. 9 is a simplified block diagram that shows various physical components of an illustrative example of a personal media player.

Like reference numerals indicate like elements in the drawings. Elements are not drawn to scale unless otherwise indicated.

### DETAILED DESCRIPTION

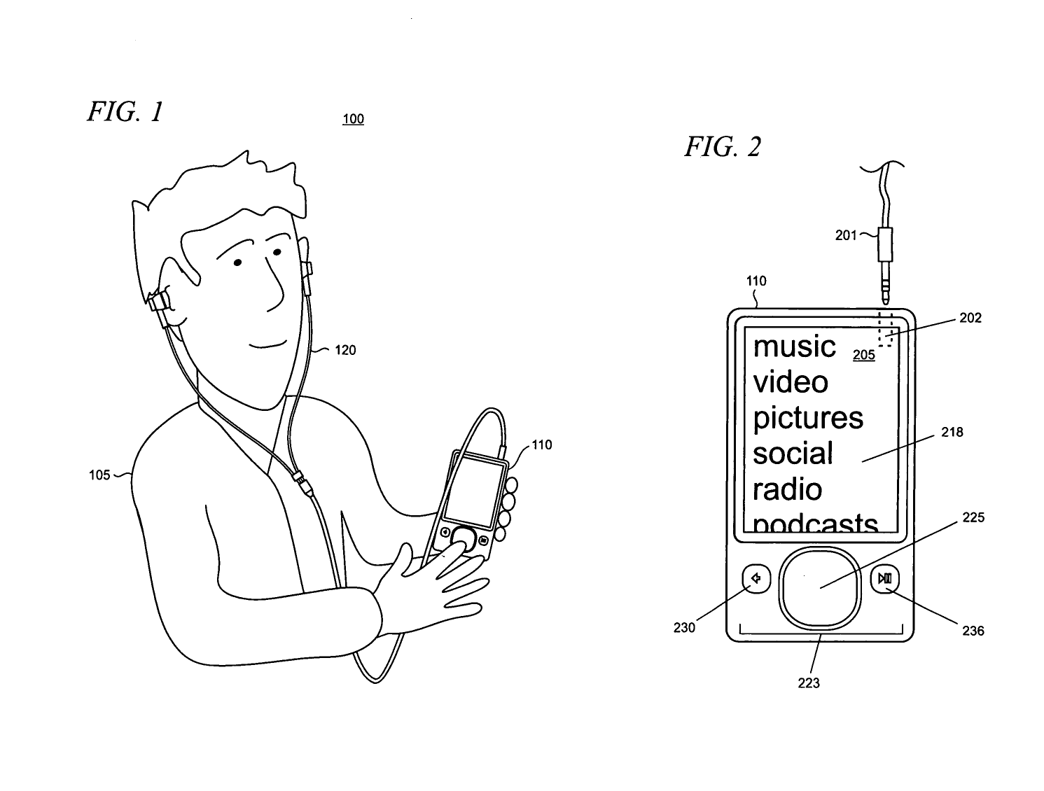

FIG. 1 shows an illustrative portable device usage environment 100 in which a user 105 interacts with digital media content rendered by a personal media player 1 10. In this example, the personal media player 110 is configured with capabilities to play audio content such as MP3 files or content from over-the-air radio stations, display video and photographs, and render other content. The user 105 will typically use earphones 120 to enable audio content, such as music or the audio portion of video content, to be consumed privately (i.e., without the audio content being heard by others) and at volume levels that are satisfactory for the user while maintaining good battery life in the personal media player. Earphones 120 are representative of a class of devices used to render audio content which may also be known as headphones, earbuds, headsets, and by other terms. Earphones 120 generally will be configured with a pair of audio speakers (one for each ear), or less commonly a single speaker, along with a means to place the speakers close to the user's ears. As shown in FIG. 2, the speakers are wired via cables to a plug 201. The plug 201 interfaces with an audio jack 202 in the personal media player 110.

FIG. 2 also shows a GUI 205 that is rendered on a display screen 218, and user controls 223 that are built in to the personal media player 110. The GUI 205 uses menus, icons, and the like to enable the user 105 to find, select, and control playback of media content that is available to the player 110. In addition to supporting the GUI 205, the display screen 218 is also used to render video content, typically by turning the player 110 to a landscape orientation so that the long axis of the display screen 218 is parallel to the ground.

The user controls 223, in this example, include a gesture pad 225, called a G-Pad, which combines the functionality of a conventional directional pad (i.e., a “D-pad”) with a touch sensitive surface as described in U.S. Patent Application Ser. No. 60/987,399, filed Nov. 12, 2007, entitled “User Interface with Physics Engine for Natural Gestural Control,” owned by the assignee of the present application and hereby incorporated by reference in its entirety having the same effect as if set forth in length. A “back” button 230 and a “play/pause” button 236 are also provided. However, other types of user controls may also be used depending on the requirements of a particular implementation.

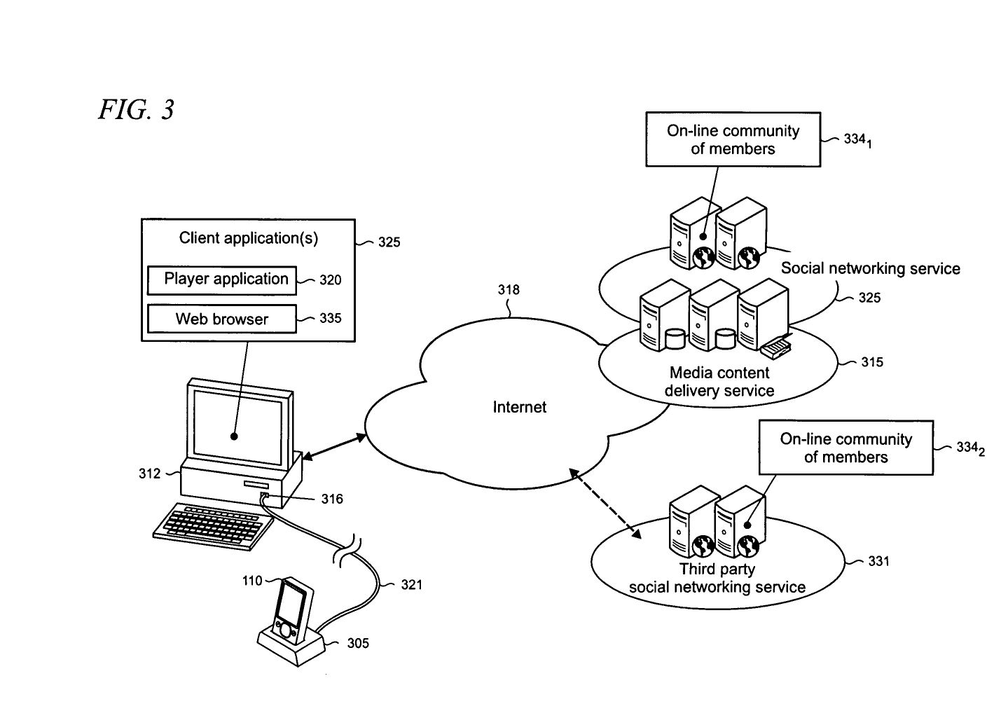

FIG. 3 shows the personal media player 110 as typically inserted into a dock 305 for synchronization with a PC 312. Dock 305 is coupled to an input port 316 such as a USB (Universal Serial Bus) port with a synchronization (“sync”) cable 321, in this example. Other arrangements may also be used to implement communications between the personal media player 110 and PC 312 including, for example, those employing wireless protocols such as Bluetooth, or Wi-Fi (i.e., the Institute of Electrical and Electronics Engineers, IEEE 802.11 standards family) that enable connection to a wireless network or access point. The wireless communications capability in the player 110 can also be utilized to implement peer-to-peer connectivity with other players that are similarly equipped.

The personal media player 110 is arranged to be operatively couplable with the PC 312 using a synchronization process by which data may be exchanged or shared between the devices. The synchronization process implemented between the PC 312 and personal media player 110 typically enables media content such as music, video, images, games, information, and other data to be downloaded from an on-line source or media content delivery service 315 over a network such as the Internet 318 to the PC 312. In this way, the PC 312 operates as an intermediary or proxy device between the service 315 and the personal media player 110.

The media content provided by the service 315 will typically be organized and presented to the user 105 using a player application 320 that runs on the PC 312. The player application 320 is arranged to enable the user 105 to browse, select, and download media content from the service 315, often on a fee basis or as part of a subscription plan. In some cases, advertising supported business models may also be utilized. The downloaded media content can be consumed on the PC 312 or be transferred to the personal media player 110. Media content may be protected in some instances where its limitations on its use may be enforced by various DRM (digital rights management) systems that interoperate between the PC 312 and the player 110.

In this example, a social networking service 325 supplements the media content delivery service 315. The social networking service 325 can be supported by a common service provider, as shown, but a service 331 may alternatively be provided by a third party (as indicated by the dashed line in FIG. 3). In each case, the social networking service will typically support an on-line community of members, as indicated by reference numerals 334₁ and 334₂.

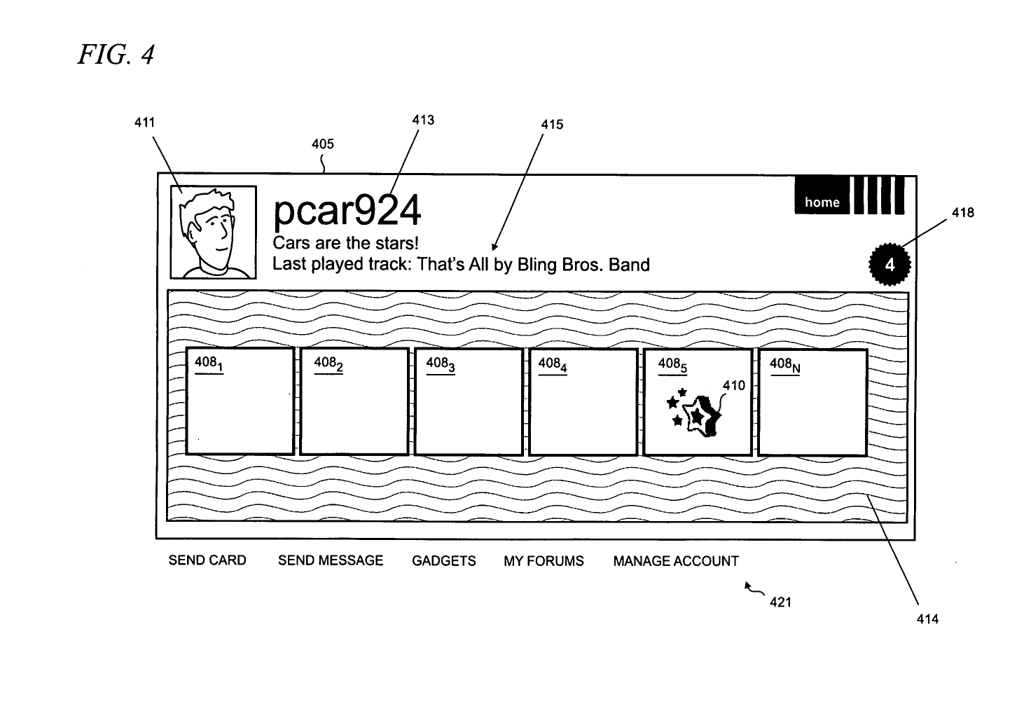

The user 105 will typically use a web browser 335 running on the PC 312 to interact with the social networking service 325. The social networking service 325 enables the online community of members 334 to explore, discover, and share media content experiences, typically including music and video. The members 334 each have a profile page featuring a member card 405 that is supported by the social networking service 325, as illustratively shown in FIG. 4.

The member card 405 is automatically updated by the service 325, in this example, to reflect the music that a member plays either on their personal media player (e.g., player 110) or on the player application (e.g., player application 320) that runs on a PC. These updates are reflected by a series of tiles 408_{1, 2 . . . N} that are arranged in a moveable filmstrip-like arrangement that may be configured to scroll horizontally across the member card 405, for example. The tiles 408 will typically show a graphical representation, or thumbnail, to represent the music and may include icons, photographs, text, etc. Typically, the tiles 408 are configured as active links to the music content that they represent.

In some cases, a tile 408 may be used as a badge or other token to indicate a particular status or reputation of a member 334 in the social network. For example a member 334 might receive a badge 410 for being a “power poster” (i.e., a member who posts beyond a certain number of posts on forums hosted by the service 325). The badges 410 can use different graphical symbols to denote different types of recognition.

A member 334 is able to pick a picture 411 to be included in the member card 405, as well as a nickname, username, or “tag” or similar type of identification 413. The member card 405 can also be customized with a member-supplied background image 414, or the member 334 can pick from an assortment of service-supplied backgrounds. The member card 405 is also arranged, in this example, to show current status information such as the last song played (as indicated by reference numeral 415) and the reputation of the member as reflected by a numerical reputation badge 418. An assortment of navigation controls, collectively identified by reference 421, is also provided as shown.

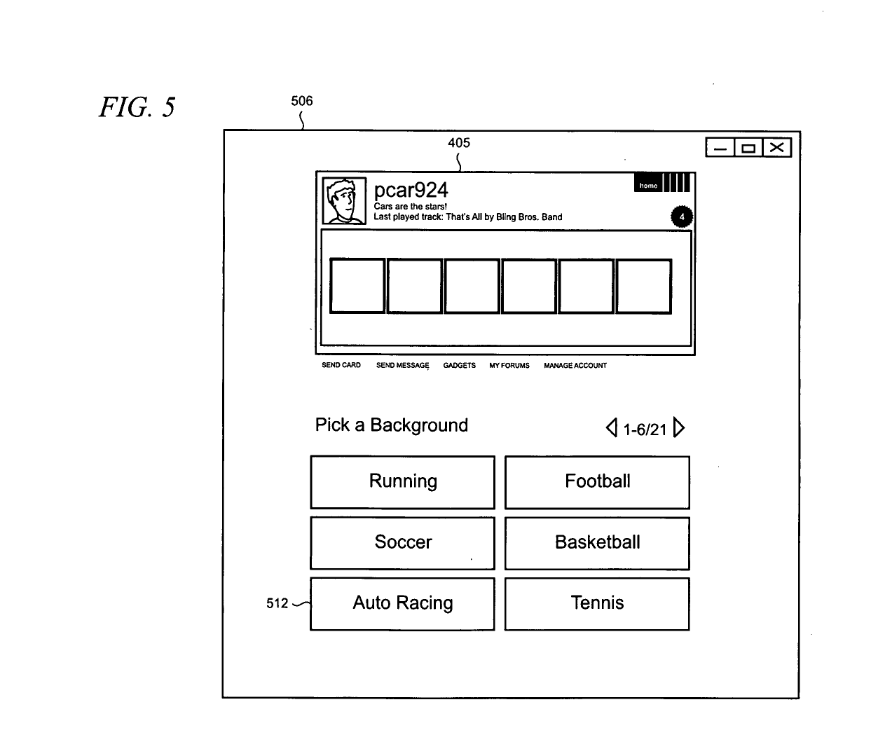

FIG. 5 shows an illustrative GUI 506 that may be supported by the web browser 335 and is arranged to enable a member 334 to select and acquire brand assets that may be used in the member card 405. GUI 506 is configured, in this particular example, to enable the member 334 to pick a background image for his member card 405 that includes a brand asset. A brand asset, as that term is used herein, is typically any kind of symbol, text, graphic, brand iconography, or combination thereof that may be used to evoke an association with a brand source. Sources can include, for example, personalities, artists, celebrities, products, services, and institutions, in both commercial and non-commercial contexts. Common examples of brand sources would include content and service providers and manufacturers of products that are targeted to consumers. It is emphasized, however, that this list is intended to be illustrative and not exhaustive.

It is also noted that while GUI 506 shown in FIG. 5 is particularly well adapted to enable selection of a background image, similar types of GUIs may also be used to select other brand assets. In addition, brand assets can also be applied and used in the player application 320 (FIG. 3) that supports the media content service in a similar manner as with the GUI that is used with the social networking service.

The illustrative GUI 506 shows a group of six categories from which branded backgrounds may be selected. By clicking on a button (as representatively indicated by reference numeral 512), the member 334 will typically be provided with an assortment or library of brand assets that are related to the selected category. In some implementations, the member 334 can choose a single brand source and/or branded background, while in others the member can select multiple branded backgrounds and/or mix and match between brand assets and sources. The arrangement of buttons and categories as shown in FIG. 5 is illustrative and other arrangements may also be utilized as required to meet the needs of a particular implementation.

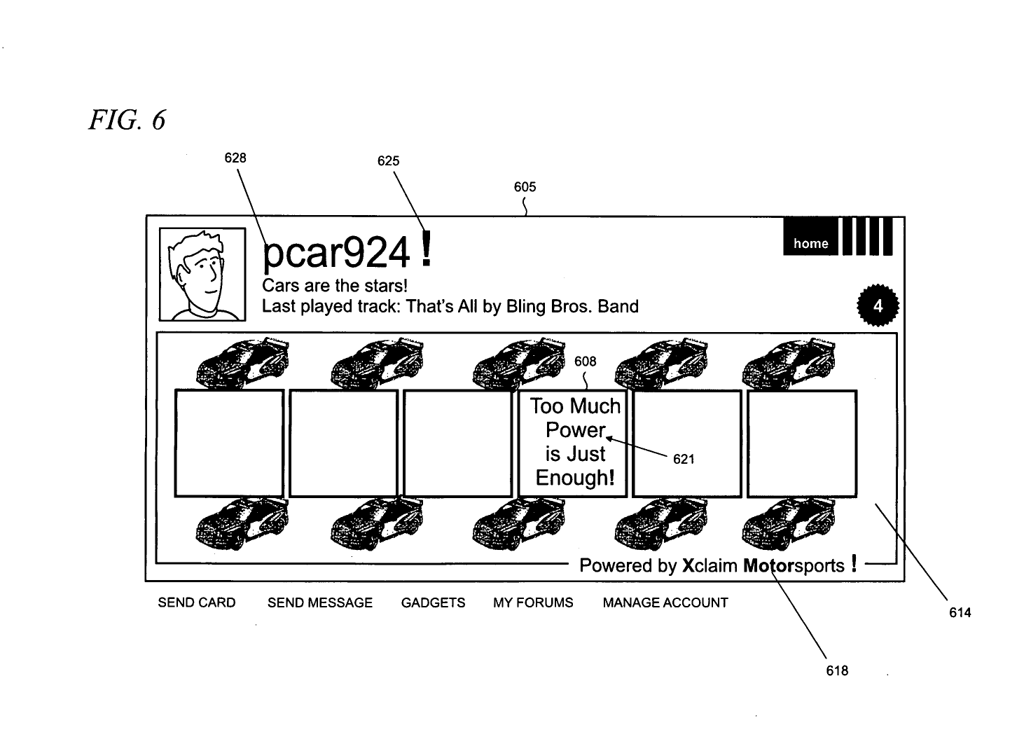

FIG. 6 shows an illustrative member card 605 that includes embedded brand assets. The embedded brand assets include a branded background 614 for the member card 605 that is associated with a particular brand source which, in this example, is a fictitious auto racing team named “Xclaim Motorsports”. The branded background 614 includes graphics that are associated with an auto racing theme and identifies the team by its logo 618. One of the tiles 608 includes the team's slogan 621 and the team's iconic exclamation point 625 is located next to the member's identification tag 628. The collection of the particular icons, slogans, logos, badges, and branded backgrounds, etc., used as brand assets for any given member card can differ from what is illustratively shown in FIG. 6 depending on the needs of a particular implementation scenario.

In one embodiment, the present arrangement creates a service 325 that utilizes its ability to manage brand assets to drive new music and media utilization scenarios by consumers. Today, consumers may not want to listen to or download unfamiliar songs if it results in a cost. Current music sites typically require a fee to download any song. This cost dissuades service members from listening to unfamiliar music and it also may prevent the music industry from expanding its set of musicians. Adding DRM to an asset to allow a temporary download is also not an attractive option to most members, who do not like the DRM technology, and also because the software on the PC client and player often have difficulty managing assets whose rights can expire. The service 325 addresses these concerns by creating an infrastructure that enables brand providers to sponsor media assets.

The brand sources or providers can choose a media asset with which to associate, and create brand assets to accompany the media asset. The service 325 assembles the brand provider's brand asset and the chosen media asset into a downloadable media card. The downloadable media card can be made available to members free of charge, and also without DRM restriction. The member downloads the branded media card, and when the asset is playing, the branded assets are displayed on the device or the PC. For example, if Xclaim Motorsports sponsored Song A from Band X, then when the member listens to Song A, the brand assets of Xclaim Motorsports, such as their logo, a branded background, and the like, may be displayed. This allows Band X to reach a new audience, who may be willing to listen to the new song at no charge, while still allowing the service 325 and the artist to receive compensation. In a specific embodiment, the service 325 tracks downloads of the media asset and charges the brand provider a set fee per download that is shared between the service 325 and the artist.

In a further embodiment, the brand source or provider may agree to provide a credit to a member to encourage the member to display their brand package for a limited time. In this embodiment, the service 325 provides the infrastructure to allow the brand provider to create a brand asset package for download, and tracks downloads and account identifiers to determine which members downloaded the brand. Then the brand providers are required to transfer their credit to the members. For example, in one embodiment, a brand provider may reward members with ten free downloads if they download their brand package.

In one specific embodiment, the package has a time and date expiration identifier, and the client PC and media player load the brand package and compare the current time and date to the expiration information. Once the expiration date has occurred, the member is free to remove the brand package from the player and PC. Until that time, the member will view the branded package. In an alternate embodiment, usage of the package is not enforced, but is only tracked. In that embodiment, the reward is not provided to the member unless the package was viewed the correct length of time.

In a further embodiment, a minimum number of views and time may be required. In this embodiment, the device must be turned on a certain number of times for the agreement to be fulfilled. Upon fulfillment, the service 325 transfers the credit to the member's account, for example, ten free song download credit. Other variations on a system that allows brand providers to create brand packages and download them to a media device, and also associate those packages with specific media assets, can be enabled by this embodiment of the present arrangement for supporting brand assets.

Members can apply actions to the brand assets so that they can be discussed by other members, rated, and shared, for example. Members 334 can be expected to embrace brand assets and use them as extensions of the personas they project to the online community to thus enable brand assets to become viral. And, brand sources will gain exposure for their brands while extending the reach of their brand and associated marketing initiatives in a more comprehensive manner than is currently supported by existing social networking services.

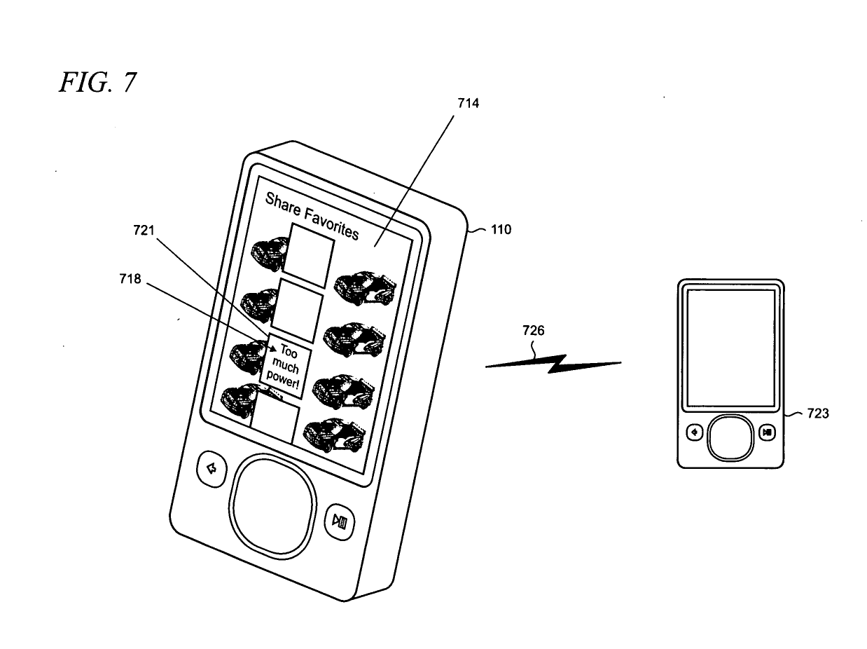

FIG. 7 shows the illustrative personal media player 110 on which a subset of brand assets from the branded member card 605 is installed. As shown, a branded background 714 is used on the player's display. And a slogan 718 is shown on a tile 721. In alternative arrangements the entire branded member card and all its brand assets may be transferred to the player 110. Transfer of member cards and assets from the PC 312 to the player 110 may be performed during data synchronization, for example. Once on the player 110, branded members cards and brand assets such as branded backgrounds and tiles may then be wirelessly transferred to another player 723 using a wireless communication protocol in support of peer-to-peer networking as indicated by arrow 726.

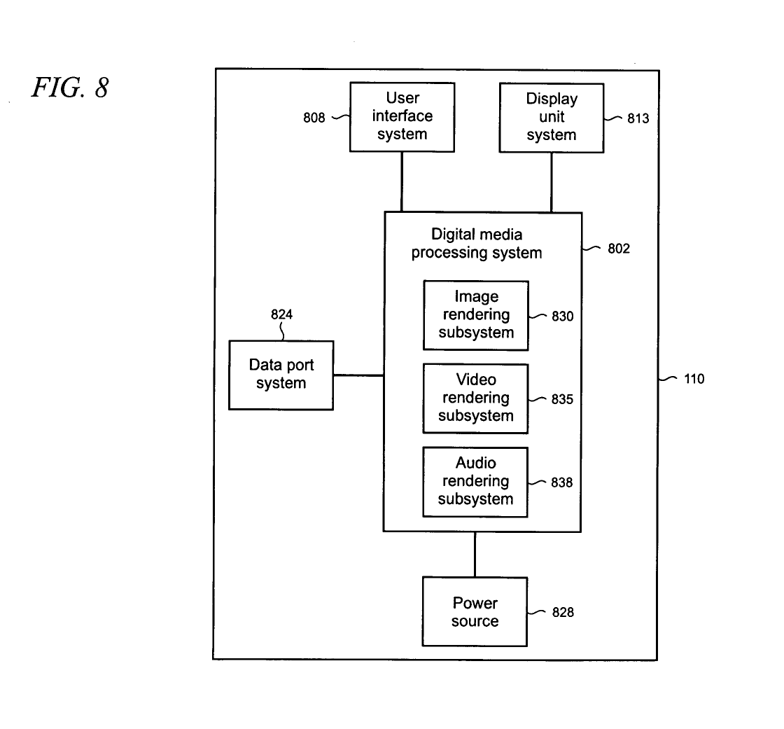

FIG. 8 is a simplified block diagram that shows various illustrative functional components of the personal media player 110. The functional components include a digital media processing system 802, a user interface system 808, a display unit system 813, a data port system 824, and a power source system 828. The digital media processing system 802 further comprises an image rendering subsystem 830, a video rendering subsystem 835, and an audio rendering subsystem 838.

The digital media processing system 802 is the central processing system for the personal media player 110 and provides functionality that is similar to that provided by the processing systems found in a variety of electronic devices such as PCs, mobile phones, PDAs, handheld game devices, digital recording and playback systems, and the like.

Some of the primary functions of the digital media processing system 802 may include receiving media content files downloaded to the player 110, coordinating storage of such media content files, recalling specific media content files on demand, and rendering the media content files into audio/visual output on the display for the user 105. Additional features of the digital media processing system 802 may also include searching external resources for media content files, coordinating DRM protocols for protected media content, and interfacing directly with other recording and playback systems.

As noted above the digital media processing system 802 further comprises three subsystems: the video rendering subsystem 835 which handles all functionality related to video-based media content files, which may include files in MPEG (Moving Picture Experts Group) and other formats; the audio rendering subsystem 838 which handles all functionality related to audio-based media content including, for example, music in the commonly-utilized MP3 format and other formats; and the image rendering subsystem 830 which handles all functionality related to picture-based media content, including for example JPEG (Joint Photographic Experts Group), GIF (Graphic Interchange Format), and other formats. While each subsystem is shown as being logically separated, each may in fact share hardware and software components with each other and with the rest of the personal media player 110, as may be necessary to meet the requirements of a particular implementation.

Functionally coupled to the digital media processing system 802 is the user interface system 808 through which the user 105 may exercise control over the operation of the personal media player 110. A display unit system 813 is also functionally coupled to the digital media processing system 802 and may comprise the display screen 218 (FIG. 2). Audio output through the audio jack 202 (FIG. 2) for playback of rendered media content may also be supported by display unit system 813. The display unit system 813 may also functionally support and complement the operation of the user interface system 808 by providing visual and/or audio output to the user 105 during operation of the player 110.

The data port system 824 is also functionally coupled to the digital media processing system 802 and provides a mechanism by which the personal media player 110 can interface with external systems in order to download media content. The data port system 824 may comprise, for example, a data synchronization connector port, a network connection (which may be wired or wireless), or other means of connectivity.

The personal media player 110 has a power source system 828 that provides power to the entire device. The power source system 828 in this example is coupled directly to the digital media processing system 802 and indirectly to the other systems and subsystems throughout the player. The power source system 828 may also be directly coupled to any other system or subsystem of the personal media player 110. Typically, the power source may comprise a battery, a power converter/transformer, or any other conventional type of electricity-providing power source.

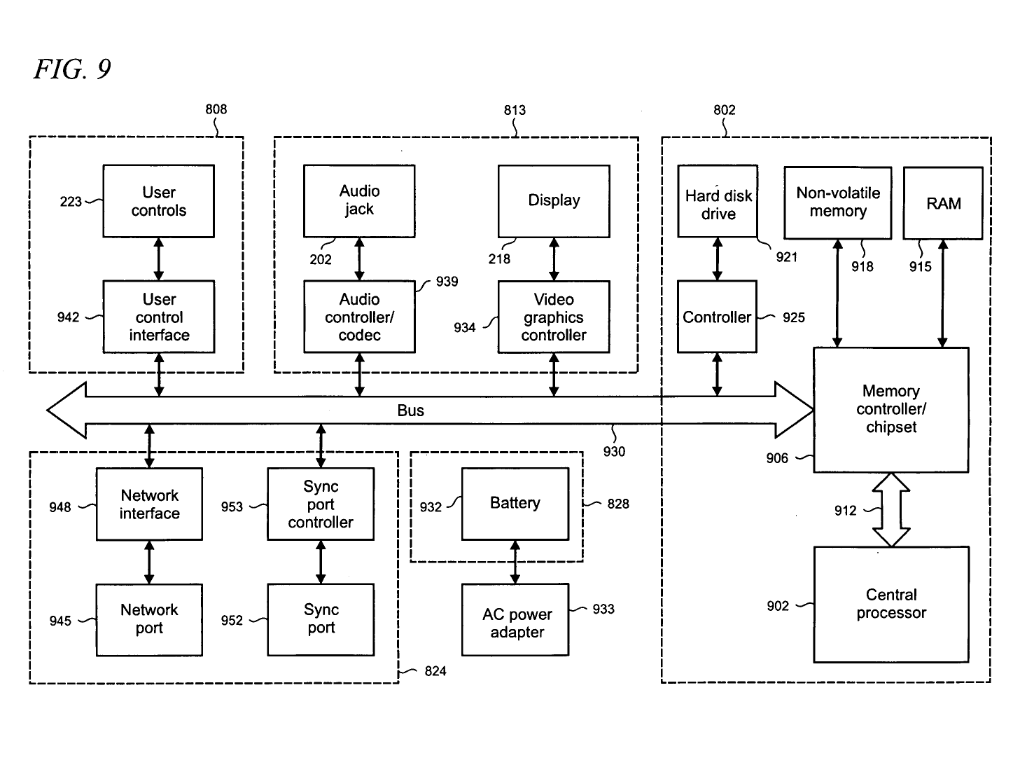

FIG. 9 is a simplified block diagram that shows various illustrative physical components of the personal media player 110 based on the functional components shown in FIG. 8 and described in the accompanying text (which are represented in FIG. 9 by dashed lines) including the digital media processing system 802, the user interface system 808, the display unit system 813, the data port system 824, and the power source system 828. While each physical component is shown as included in only a single functional component in FIG. 9, the physical components may, in fact, be shared by more than one functional component.

The physical components include a central processor 902 coupled to a memory controller/chipset 906 through, for example, a multi-pin connection 912. The memory controller/chipset 906 may be, in turn, coupled to random access memory (“RAM”) 915 and/or non-volatile memory 918 such as solid-state or Flash memory. These physical components, through connectivity with the memory controller/chipset 906, may be collectively coupled to a hard disk drive 921 (or other solid-state memory) via a controller 925, as well as to the rest of the functional component systems via a system bus 930.

In the power supply system 828, a rechargeable battery 932 may be used to provide power to the components using one or more connections (not shown). The battery 932, in turn, may also be coupled to an external AC power adapter 933 or receive power via the sync cable 321 when it is coupled to the PC 312 (FIG. 3).

The display screen 218 is associated with a video graphics controller 934. The video graphics controller will typically use a mix of software, firmware, and/or hardware, as is known in the art, to implement the GUI on the display screen 218. Along with the audio jack 202 and its associated audio controller/codec 939, these components comprise the display unit system 813 and may be directly or indirectly connected to the other physical components via the system bus 930.

The user controls 223 are associated with a user control interface 942 in the user interface system 808 that implements the user control functionality that is used to support the interaction with the GUI as described above. A network port 945 and associated network interface 948, along with the sync port 952 and its associated controller 953 may constitute the physical components of the data port system 824. These components may also directly or indirectly connect to the other components via the system bus 930.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for supporting brand assets in a user profile page supported by a social networking service, the method comprising the steps:
providing a portal from which a user may browse and select from an assortment one or more brand assets for inclusion in the profile page, the brand assets being usable to evoke a connection with a brand source;
embedding a selected brand asset in the profile page;
enabling the user to manipulate the brand assets on the profile page including at least one of sharing the brand assets, receiving ratings on the brand assets from social network members, and discussing the brand assets.

2. The method of claim 1 in which the profile page includes a member card that is arranged to be updated by the service to reflect consumption of media content by the user.

3. The method of claim 2 in which the member card is further arranged to include tiles representing ones of links to the consumed media content or badges that are indicative of reputation.

4. The method of claim 1 including the further steps of receiving uploads of personalized content from the user and embedding the personalized content in the profile page, the personalized content comprising at least one of pictures, backgrounds, or updates.

5. The method of claim 1 in which the brand sources comprise one of service provider or product manufacturer.

6. A computer-readable medium containing instructions which, when executed by one or more processors disposed in an electronic device, implement a platform supporting use of brand assets on a user profile page attendant to a social network, the platform performing a method comprising the steps of:
showing on a GUI an assortment from which a member of the social network may select one or more brand assets to be associated with the member;
enabling selection of brand assets by the user; and
transferring the selected brand assets to a personal media player

7. The computer-readable medium of claim 6 in which the brand assets are associated with one of personalities, artists, celebrities, products, services, or institutions.

8. A personal media player, comprising:
a digital media processing system and a display screen, the digital media processing system interfacing with the display screen to render digital media content in the form of images or video;
memory bearing computer-readable instructions which, when executed by one or more processors in the personal media player, support a GUI that is rendered on the display screen, the GUI being arranged to show brand assets received from a remote host device; and
memory bearing computer-readable instructions which, when executed by one or more processors in the personal media player, enable transfer of selected brand assets to a remote personal media player.

9. The personal media player of claim 8 in which the transfer is implemented using a wireless peer-to-peer networking protocol.

10. The personal media player of claim 9 in which networking protocol conforms to IEEE 802.11.

11. The personal media player of claim 8 in which the brand assets are implemented using one of logo, slogan, graphic, iconography, background, photograph, text, or a combination thereof.
